(19) United States
(12) Patent Application Publication
(10) Pub. No.: US 2007/0104942 A1
(43) Pub. Date: May 10, 2007

(54) ADHESIVE TAPE PROVIDED WITH A POLYURETHANE FOAM SUPPORT

(75) Inventors: Anke Lewin, Duesseldorf (DE); Wolfgang Klauck, Meerbusch (DE); Reinhold Domanski, Neuwied (DE)

Correspondence Address: HENKEL CORPORATION, THE TRIAD, SUITE 200, 2200 RENAISSANCE BLVD., GULPH MILLS, PA, 19406, US

(73) Assignees: Henkel Kommanditgesellschaft auf Aktien (Henkel KGaA), Duesseldorf (DE); Lohmann GmbH & Co. KG, Neuwied (DE)

(21) Appl. No.: 11/609,357

(22) Filed: Dec. 12, 2006

Related U.S. Application Data
(63) Continuation of application No. PCT/EP05/06181, filed on Jun. 9, 2005.

(30) Foreign Application Priority Data
Jun. 25, 2004 (DE) 20 2004 009 995.0

(51) Int. Cl. B32B 3/00; B32B 7/12

(52) U.S. Cl. 428/317.3; 428/314.4; 428/317.1; 428/317.7; 428/343

(57) ABSTRACT

Adhesive tape with a two-sided polyurethane foam backing, each side coated with two different adhesives in distinct segments, one adhesive having high initial bond strength and the other having high ultimate bond strength.

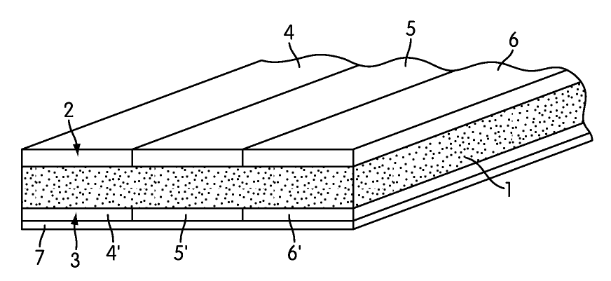

### CROSS REFERENCE TO RELATED APPLICATIONS

This application is a continuation under 35 U.S.C. § 365(c) and 35 U.S.C. § 120 of international application PCT/EP2005/006181, filed on Jun. 9, 2005. This application also claims priority under 35 U.S.C. § 119 of DE 20 2004 009 995.0, filed Jun. 25, 2004, which is incorporated herein by reference in its entirety.

### BACKGROUND OF THE INVENTION

The invention relates to an adhesive tape comprising a backing having one first side and one second side.

Adhesive tapes are known, and available on the market, in a great multiplicity of forms. They are generally composed of a backing comprising a relatively thin flexible polymeric film coated with an adhesive. Typically backing materials are polypropylene, polyethylene, polyethylene terephthalate, polyvinyl chloride and acetate film and also fabric backings and foam backing materials. Adhesive tapes are used for joining or bundling articles, for sealing or, for example, in the context of painting operations, for masking, i.e. for hiding areas which are not to be covered with paint.

The backing of adhesive tapes may be coated on one or both sides with adhesive. Adhesive tapes coated with adhesive on both sides are also referred to as assembly tapes and are used for the purpose of fastening articles having at least one planar side to a planar substrate. They can be used, for example, to fasten pictures, mirrors or signs to a wall.

The adhesives for producing adhesive tapes may be selected from a great multiplicity of customary materials. The materials in question may, for example, be SIS rubbers, SBS rubbers, polyisobutylenes, polyisoprenes, polyacrylates and natural rubbers, with or without the addition of tackifying natural and/or synthetic resins. On the basis of their different chemical composition the various adhesives have naturally different properties. Important quality features of an adhesive assembly tape are initial adhesion, bond strength to the substrate, cohesion of the adhesive, thermal stability and ultimate strength. In the context of adhesive tape application it is important to press the assembly tape effectively onto the particular substrate in order to ensure effective wetting of the tape to the substrate. The tape achieves its ultimate strength when the maximum possible wetting of the adhesive to the substrate has been achieved. In order to flow into the microscopic surface unevennesses the pressure-sensitive adhesive generally requires a certain time. The process is favored by relatively high temperatures and a strong pressing force. Adhesives which attain a high ultimate strength and a high thermal stability generally require a relatively long time in order to perform this wetting operation. On the other hand there are adhesives which exhibit a high tack and are relatively fluid; these adhesives wet the bond substrate much more quickly and therefore also adhere much more quickly to the particular substrate. These adhesives, however, generally do not achieve high ultimate strengths and thermal stabilities.

### DESCRIPTION OF THE INVENTION

It is an object of the present invention to specify an adhesive tape which on the one hand, immediately following its application, leads to a bond with a relatively high load-bearing capacity and after a certain time leads to a bond having a very high load-bearing capacity and on the other hand is suitable for joining articles which exhibit minimal surface unevennesses.

This object is achieved in the case of an adhesive tape of the type specified at the outset by virtue of the fact that the backing is a polyurethane foam tape and that the first and second sides each have at least two segments coated with different adhesives of which at least one first adhesive has a high initial bond strength and at least one second adhesive has a high ultimate bond strength.

An adhesive tape in which on one side different adhesives cover segments of the backing that border one another is known in principle from patent application US 2002/0108564 A1. The inventively essential combination with a polyurethane foam tape, leading to particular high-performance assembly tapes, is not specified in that patent application, however.

The segments which carry the different adhesives are advantageously designed as adjacent strips which extend in the longitudinal direction of the adhesive tape. A tape of this kind can be easily produced by applying the adhesives in strip form to the backing, and also affords considerable advantages in its application.

On each side of the adhesive tape it is possible to combine two or more adhesives with one another, disposed adjacently in strip form, there being no limit to the number of strip-form segments. In the case of the adhesive tape of the invention it is particularly advantageous, however, if on each side of the backing a first strip-form segment is coated with an adhesive having high initial bond strength and two further strip-form segments, bordering the longitudinal sides of the first strip-form segment, are coated with an adhesive having high ultimate bond strength. The adhesive strip with high initial bond strength thus extends in the middle of the tape, while the adhesive strips with high ultimate bond strength extend at the edges. The three strips may each occupy one third of the width of the adhesive tape, but it is also possible to vary the strip width accordingly in favor of a high initial bond strength or in favor of a high ultimate bond strength.

The adhesive tape advantageously exhibits on stainless steel after one minute a bond strength of >12 N/25 mm and after 24 hours a bond strength of >30 N/25 mm, this bond strength being the peel strength as measured by the PSTC-1 test method. The test method was developed by the Pressure Sensitive Tape Council, a federation of American adhesive tape manufacturers. According to the test conditions the bond strength is the force required to remove an adhesive strip in a defined width under defined conditions (peel angle, applied pressure, speed) from a standard test plate. For testing, a section of adhesive tape with a length of about 400 mm and a sample width of 25 mm is applied to a stainless steel plate 200 mm long, 50 mm wide and approximately 2 mm thick and is pressed on uniformly using a rubber-coated metal roller weighing 2 kg. About 25 mm of adhesive tape are peeled from the steel plate prepared in this way. The steel plate is fixed in the testing instrument using a carrier clamp, and the free end of the tape is fastened to another clamp. At a defined speed of 300 +/−30 mm per minute the adhesive tape is peeled at an angle of 180° from the steel plate, the testing instrument displaying the bond strength values. After the end of the test a mean value is calculated which represents the bond strength value on steel. This value is expressed with the force (N) required to peel the adhesive tape from the steel surface for a sample width of 25 mm.

With particular preference the adhesives and the adhesive tape overall have the following properties:

Adhesive having high initial bond strength:

Peel strength on steel after 1 minute: >40 N/25 mm

Peel strength on steel after 24 hours: >50 N/25 mm

Temperature stability ≧50° C.

Adhesive having high ultimate bond strength:

Peel strength on steel after 1 minute: >15 N/25 mm

Peel strength on steel after 24 hours: >30 N/25 mm

Temperature stability ≧100° C.

Adhesive tape overall:

Peel strength on steel after 1 minute: >12 N/25 mm

Peel strength on steel after 24 hours: >30 N/25 mm

Temperature stability ≧95° C.

Besides the bond strength the temperature stability is a further quality feature of an adhesive tape. With advantage the adhesive having high initial bond strength exhibits a temperature stability of ≧70° C. and the adhesive having high ultimate bond strength exhibits a temperature stability of ≧100° C. The adhesive having high initial bond strength is advantageously a synthetic rubber adhesive, preferably a styrene-isoprene-styrene rubber, and the adhesive having high ultimate bond strength is advantageously an acrylate adhesive, preferably an acrylate adhesive based on 2-ethyl acrylate.

The adhesive tape advantageously has a release film at least on one of the adhesive-coated sides of the backing. A release film of this kind is also referred to as a release liner. It facilitates the handling of the adhesive tape prior to its use and in particular makes it possible for the tape to be wound up and also unwound easily for the use of the adhesive tape.

The adhesive tape of the invention can be produced by methods which are well known in the art, by coating the filmed foam backing with the different adhesives in strip form using known coating machines.

A working example of the invention is illustrated below with reference to the drawing.

The figure shows in a perspective view an adhesive tape according to the invention. This tape is composed of a polyurethane foam backing 1. Disposed on the first side 2 and second side 3 of the backing are adhesive-coated segments 4, 5 and 6 and 4′, 5′ and 6′. In this case the segments 5 and 5′ are coated with an adhesive having high initial bond strength and the segments 4, 4′, 6 and 6′ are coated with an adhesive having high ultimate bond strength. A release film 7 is disposed on one side of the adhesive tape.

As used herein, and in particular as used herein to define the elements of the claims that follow, the articles “a” and “an” are synonymous and used interchangeably with “at least one” or “one or more,” disclosing or encompassing both the singular and the plural, unless specifically defined otherwise. The conjunction “or” is used herein in its inclusive disjunctive sense, such that phrases formed by terms conjoined by “or” disclose or encompass each term alone as well as any combination of terms so conjoined, unless specifically defined otherwise. All numerical quantities are understood to be modified by the word “about,” unless specifically modified otherwise or unless an exact amount is needed to define the invention over the prior art.

What is claimed is:

1. An adhesive tape comprising a polyurethane foam tape backing having first and second sides, wherein the first and second sides each have at least two segments each coated with a different adhesive, wherein at least one first adhesive has a high initial bond strength and at least one second adhesive has a high ultimate bond strength.

2. The adhesive tape of claim 1, wherein the segments comprise adjacent strips extending in the longitudinal direction of the adhesive tape.

3. The adhesive tape of claim 2, wherein on each side of the backing a first strip-form segment is coated with an adhesive having high initial bond strength and two further strip-form segments on either side of the first strip-formed segment are coated with an adhesive having high ultimate bond strength.

4. The adhesive tape of claim 1, having after one minute a bond strength of >12 N/25 mm and after 24 hours a bond strength of >30 N/25 mm, as measured by the PSTC-1 test method on stainless steel.

5. The adhesive tape of claim 1, wherein the adhesive having high initial bond strength has a temperature stability of ≧70° C. and the adhesive having high ultimate bond strength has a temperature stability of ≧100°0 C.

6. The adhesive tape of claim 1, wherein the adhesive having high initial bond strength comprises a synthetic rubber adhesive and the adhesive having high ultimate bond strength comprises an acrylate adhesive.

7. The adhesive tape of claim 1, wherein the backing comprises of a closed-cell polyurethane foam.

8. The adhesive tape of claim 1, having a release film o at least one of the adhesive-coated sides of the backing.

9. The adhesive tape of claim 2, having after one minute a bond strength of >12 N/25 mm and after 24 hours a bond strength of >30 N/25 mm, as measured by the PSTC-1 test method on stainless steel.

10. The adhesive tape of claim 3, having after one minute a bond strength of >12 N/25 mm and after 24 hours a bond strength of >30 N/25 mm, as measured by the PSTC-1 test method on stainless steel.

11. The adhesive tape of claim 2, wherein the adhesive having high initial bond strength has a temperature stability of ≧70° C. and the adhesive having high ultimate bond strength has a temperature stability of ≧100° C.

12. The adhesive tape of claim 3, wherein the adhesive having high initial bond strength has a temperature stability of ≧70° C. and the adhesive having high ultimate bond strength has a temperature stability of ≧100° C.

13. The adhesive tape of claim 4, wherein the adhesive having high initial bond strength has a temperature stability of ≧70° C. and the adhesive having high ultimate bond strength has a temperature stability of ≧100° C.

14. The adhesive tape of claim 2, wherein the adhesive having high initial bond strength comprises a synthetic rubber adhesive and the adhesive having high ultimate bond strength comprises an acrylate adhesive.

15. The adhesive tape of claim 3, wherein the adhesive having high initial bond strength comprises a synthetic rubber adhesive and the adhesive having high ultimate bond strength comprises an acrylate adhesive.

16. The adhesive tape of claim 4, wherein the adhesive having high initial bond strength comprises a synthetic rubber adhesive and the adhesive having high ultimate bond strength comprises an acrylate adhesive.

17. The adhesive tape of claim 5, wherein the adhesive having high initial bond strength comprises a synthetic rubber adhesive and the adhesive having high ultimate bond strength comprises an acrylate adhesive.

18. The adhesive tape of claim 4, wherein the backing comprises a closed-cell polyurethane foam.

19. The adhesive tape of claim 5, wherein the backing comprises a closed-cell polyurethane foam.

20. The adhesive tape of claim 6, wherein the backing comprises a closed-cell polyurethane foam.
